(19) United States
(12) Patent Application Publication
(10) Pub. No.: US 2013/0340639 A1
(43) Pub. Date: Dec. 26, 2013

(54) METHOD AND APPARATUS FOR GENERATING A PRINTING MEMBER

(71) Applicants: Edul N. DALAL, Webster, NY (US); Dan René RASMUSSEN, Pittsford, NY (US)

(72) Inventors: Edul N. DALAL, Webster, NY (US); Dan René RASMUSSEN, Pittsford, NY (US)

(73) Assignee: XEROX CORPORATION, Norwalk, CT (US)

(21) Appl. No.: 13/529,581

(22) Filed: Jun. 21, 2012

(51) Int. Cl. B41N 1/00

(52) U.S. Cl. 101/466

(57) ABSTRACT

An approach is provided for generating a printing member. The approach involves determining one or more image areas associated with printing one or more images, the one or more image areas being positioned on a surface of a substrate. The approach also involves determining a liquid interaction behavior of at least the surface of substrate is one of hydrophobic or hydrophilic. The approach further involves causing, at least in part, a substance that is the other of the determined liquid interaction behavior of the surface of the substrate to be applied to the one or more image areas on the surface of the substrate by a jetting process. In one embodiment, the printing member is mounted inside a printing system when the substance is applied. In one embodiment, the surface may be completely or partially cleaned and a new image created by another application of the substance.

### FIELD OF DISCLOSURE

The disclosure relates to an apparatus, method and system for generating a printing member by way of a jetting process. The printing member is useful in printing one or more images onto a media by way of an offset lithography printing process. The printing member may optionally be automatically cleaned and reused.

### BACKGROUND

Offset lithography is a printing process for printing an image onto a media, utilizing a lithographic printing plate. Lithographic printing plates conventionally have hydrophobic image areas and hydrophilic non-image areas on a metallic plate. In operation, the lithographic printing plate is wrapped around a plate cylinder inside of a printing system and first exposed to a water-based “fountain solution” that moistens the non-image hydrophilic areas. Oil-based ink is then applied by means of a roller train. The oil-based ink adheres to the hydrophobic image areas of the lithographic plate, and is then transferred to an offset roll or “blanket.” Next, the oil-based ink is transferred from the offset roll to the media upon which the printed image is to be applied such as a paper product or polymer film, for example.

Lithographic printing processes are capable of high speed, high quality, and low cost long print runs. Lithographic printing, however, is very expensive and inconvenient for short print runs because lithographic plates are expensive to generate, take time to mount and align inside the printing system, and often require a large number of test sheets to align the conventional lithographic printing plate inside the printing system.

Inkjet printing is a class of printing processes that ejects tiny drops of ink onto a substrate. The actual ejection mechanism could involve heat (thermal inkjet), pressure (piezo inkjet), acoustic energy, etc. Inkjet printers can handle variable data, e.g., print run lengths ranging from thousands of sheets to print runs as low as a single sheet. Inkjet printing can also produce high image quality on special substrates, but generally sacrifices quality on ordinary paper substrates when compared to lithographic printing.

### SUMMARY

Therefore, there is a need for an approach to perform lithographic printing more economically for short runs. One such approach is based on a jetting process.

According to one embodiment, a method for generating a printing member comprises determining a liquid interaction behavior of at least the surface of substrate is one of hydrophobic or hydrophilic. The method also comprises determining one or more image areas associated with printing one or more images, the one or more image areas being positioned on a surface of a substrate. The method further comprises causing, at least in part, a substance that is the other of the determined liquid interaction behavior of the surface of the substrate to be applied to the one or more image areas on the surface of the substrate by a jetting process.

According to another embodiment, an apparatus for generating a printing member comprises at least one processor, and at least one memory including computer program code for one or more computer programs, the at least one memory and the computer program code configured to, with the at least one processor, cause, at least in part, the apparatus to determine a liquid interaction behavior of at least the surface of substrate is one of hydrophobic or hydrophilic. The apparatus is also caused to determine one or more image areas associated with printing one or more images, the one or more image areas being positioned on a surface of a substrate. The apparatus is further caused to cause, at least in part, a substance that is the other of the determined liquid interaction behavior of the surface of the substrate to be applied to the one or more image areas on the surface of the substrate by a jetting process.

Exemplary embodiments are described herein. It is envisioned, however, that any system that incorporates features of any apparatus, method and/or system described herein are encompassed by the scope and spirit of the exemplary embodiments.

### BRIEF DESCRIPTION OF THE DRAWINGS

The embodiments of the invention are illustrated by way of example, and not by way of limitation, in the figures of the accompanying drawings:

FIG. 1 is a diagram of a system capable of generating a printing member by way of a jetting process, according to one embodiment;

FIG. 2 is a diagram of a printing system that includes an apparatus capable of generating a printing member by way of a jetting process on-demand, according to one embodiment;

FIG. 3 is a diagram of a substance applied to various image areas on a surface of a substrate for generating a printing member, according to one embodiment;

FIG. 4 is a flowchart of a process for generating a printing member by way of a jetting process, according to one embodiment; and

FIG. 5 is a diagram of a chip set that can be used to implement an embodiment.

### DETAILED DESCRIPTION

Examples of a method and apparatus for generating a printing member by way of a jetting process are disclosed. In the following description, for the purposes of explanation, numerous specific details are set forth in order to provide a thorough understanding of the embodiments of the invention. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

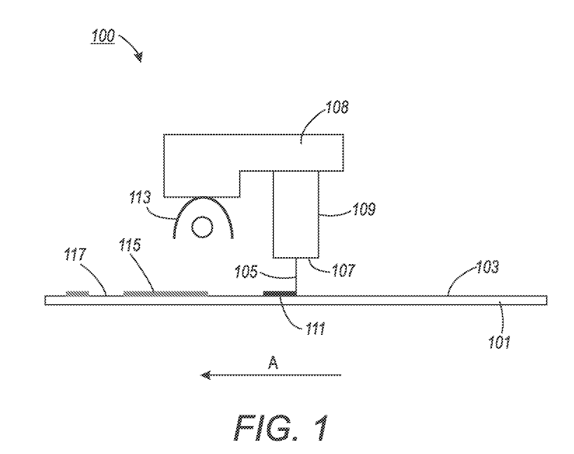

FIG. 1 is a diagram of a system capable of generating a printing member by way of a jetting process, according to one embodiment. Offset lithography is a printing process for printing an image onto a media, utilizing a lithographic printing plate. Lithographic printing plates conventionally have hydrophobic image areas and hydrophilic non-image areas on a metallic plate. In operation, the lithographic plate is wrapped around a plate cylinder inside of a printing system and first exposed to a water-based “fountain solution” that moistens the non-image hydrophilic areas. Oil-based ink is then applied by means of a roller train. The oil-based ink adheres to the hydrophobic image areas of the lithographic plate, and is then transferred to an offset roll or “blanket.” Next, the oil-based ink is transferred from the offset roll to the media upon which the printed image is to be applied such as a paper product or polymer film, for example.

Lithographic printing processes are capable of high speed, high quality, and low cost long print runs. Lithographic printing, however, is very expensive and inconvenient for short print runs because lithographic printing plates are expensive to generate, take time to mount and align inside the printing system, and often require a number of test sheets to align the conventional lithographic printing plate inside the printing system. Accordingly, the high cost of making lithographic printing plates, the time associated with mounting and aligning conventional lithographic printing plates, and the costs associated with adjusting conventional lithographic printing plates make short-run printing processes cost-prohibitive and inefficient. Further, some printing product manufacturers use valuable factory space to store conventional lithographic printing plates for future use to reduce their overall process costs and waste.

Conventional lithographic plates are typically made of a sheet of anodized aluminum with a thin uniform coating of a photopolymer material. The photopolymer, which can be positive or negative, is exposed to ultraviolet (UV) light image-wise. In older systems, some of which are still in use, the exposure is performed through a photographic film. In newer Computer-to-Plate (CTP) systems, exposure is done with a laser. For negative photopolymer, the coating becomes insoluble after exposure while the unexposed coating remains soluble, and vice versa. After exposure, the soluble portion of the coating is washed off, resulting in hydrophobic image areas where the coating remains, and hydrophilic non-image areas where the coating was removed and the bare plate is exposed.

Inkjet printing is a class of printing processes that ejects tiny drops of ink onto a substrate. The actual ejection mechanism could be heat (thermal inkjet), pressure (piezo inkjet), acoustic energy, etc. Inkjet printers can handle variable data, e.g., run lengths of thousands of sheets down to run lengths of a single copy. Inkjet printing can also produce high quality on special substrates, but quality on ordinary paper is typically poor. For example, images formed by inkjet printing often bleed because of the absorptivity of paper media. Multi-pass inkjet print heads are inexpensive, but slow compared to lithographic printing processes. Inexpensive print heads are typically narrow, and need to be scanned across the page width. Single-pass (i.e. full-width) print heads are faster than inexpensive narrow, multi-pass print heads, but much more expensive. Additionally, aligning inkjet print head components can be a challenge.

Inkjet printers, which are more readily adaptable for short-run printing than offset lithographic printing systems, can print over a range of speeds, but there is generally a trade-off between print speed and image quality. As such, inkjet printing, though useful for short-run printing processes, cannot compete with the quality and speed of a lithographic printing process.

To address this problem, a system 100 of FIG. 1 introduces the capability to generate a printing member by way of a jetting process similar to inkjet printing techniques. Because inkjet printers are capable of short run printing on a variety of substrates, a hybrid printing approach for producing high quality lithographic printed images is provided without enduring the expense of conventional lithographic printing plate generation and without producing the amount of waste associated with conventional lithographic printing plate generation processes.

For example, the system 100, in one or more embodiments, is configured to generate a printing member 101 having image-wise hydrophobic and hydrophilic areas created on a surface of a substrate 103 used as a basis for the printing member 101. The substrate and/or the surface of the substrate 103 may comprise aluminium, one or more polymers, or any other metal, or material that has hydrophobic or hydrophilic properties that can be used as a substrate for generating a lithographic printing member such as printing member 101. For example, in one embodiment, the substrate 103 may be hydrophilic, such as an anodized aluminium sheet like that used for conventional lithographic plates. Or, in another embodiment, a low-cost hydrophilic metalized polyester film may be used as the substrate 103 for some less demanding applications.

In some embodiments, the system 100 may be specifically configured to generate a printing member 101 for only hydrophobic or only hydrophilic substrates 103. Alternatively, the system 100 may be configured to accommodate both hydrophobic or hydrophilic substrates 103, and may also be configured to switch between different types of substrates 103 on the fly or on-demand based on a determined substrate type, material, or determined hydrophobic or hydrophilic properties, for example.

The system 100 is configured to advance the substrate 103 in a process direction A and apply a substance 105 that may be a liquid or gel that has properties opposite that of the substrate 103. The system 100 applies the substance 105 to the substrate 103 by one or more jets 107 that, in some embodiments, may be similar to conventional inkjets, or the jets 107 may be configured to specifically apply the substance 105. For example, the system 100 may have print heads 109 that include the jets 107 for applying the substance 105 to the substrate 103 in a specific pattern that corresponds to one or more images that are to be printed onto a media by a printing system.

In one or more embodiments, the print heads 109 may be associated with a carriage 108 that is configured to move at least one of the one or more print heads 109 during a process for applying the substance 105 to vary the range of coverage of the substance 105 over the substrate 103, for example. The substance 105 applied to the substrate 103 is not an ink, and may be pigmented or colorless in any of a liquid or gel state, for example.

The substance 105 is applied to the surface of the substrate 103 in one or more image areas that are associated with one or more images that are to be printed by a printing system onto a media. For example, if the substrate 103 is hydrophilic the system 100 causes a hydrophobic substance 105 such as a polymeric liquid or gel to be applied to the substrate 103 in one or more image areas 111 that correspond to one or more images that are to be printed on a media by a printing system that uses the printing member 101. The substance 105 applied to the one or more image areas 111 is precise such that only the image areas 111 receive the substance 105 and other non-image areas remain bare.

In one or more embodiments, the substance 105 may be capable of being crosslinked and thereby optionally hardened by a hardening device 113. The hardening device 113 subjects the substance 105, once applied to image areas 111, to at least one hardening process. The hardening device 113 may be any device that comprises one or more of a lamp that generates ultraviolet light to enable UV curing, a heating element for heating the substance 105, an electron beam source to facilitate electron beam curing, etc., for improved wear resistance and strong adhesion to the substrate 103. As such, the substance 105 applied to the one or more image areas 111 becomes a hardened image 115 that is used by a printing system to print an image that corresponds to the one or more image areas 111 (and also the hardened image 115) onto a media.

However, in other embodiments, the substance 105 may optionally remain uncured after application to aid in removal of the substance 105 from the image areas 111 on the substrate 103 to facilitate re-use of the substrate 103, for example. The substance 105 applied to the image areas 111 adheres to the substrate 103 regardless of whether the substance 105 is hardened or not hardened. If the substance 105 is hydrophobic, the substance 105 prevents its wetting with water. Water is typically used in lithographic printing to prevent ink from being applied to any bare spaces 117 of the printing member 101, for example. Simply applying the substance 105 may, in some embodiments, be usable for the printing member 101 for a range of a few prints to a few hundred prints. However, for longer print runs of multiple copies, it may be necessary to use materials for the substance 105 that cross-link for improved wear resistance and strong adhesion to the substrate 103, or use a substance 105 that has a high wear resistance without hardening.

As discussed above, if the substrate 103 is hydrophilic, the hydrophobic substance 105 is applied directly to the one or more image areas 111 using print heads 109. Such a process enables precise application of the substance 105 to only the image areas 111 that are associated with printing one or more images onto a media. Conversely, conventional printing plate generation processes apply a hydrophobic polymer to an entire substrate, cure the substance to form the polymer over the one or more images areas on the surface of the substrate using a film, filter, or laser, for example, and then remove the hydrophobic polymer from the non-image areas. Such a conventional process is wasteful and is harmful to the environment. Excessive application of hydrophobic polymer to the surface of the substrate and stripping of the excess hydrophobic polymer wastes not only the hydrophobic polymer, but also creates waste water during a washing step.

The system 100, however, generates the printing member 101 by applying a positive image by jetting the substance 105 onto the substrate 103 which may be, as discussed above, a bare (i.e., without photopolymer coating) anodized aluminium sheet, or other material, that is mounted in the system 100, or is advanced through the system 100, for example. The positive image is applied to the one or more image areas 111 on the substrate 103 by the jets 107. As discussed above, the substance 105 applied to image areas 111 is optionally subjected to a hardening process such as exposure to UV radiation, heat treatment, or electron beam exposure, for example, thereby curing and hardening the imaging substance. The printing member 101 is now ready for use by a printing system, with no further washing, drying, removal of excess hydrophobic substances, or any other processing required. In addition to the cost, process time and environmental benefits provided by the system 100 compared to conventional printing plate generation systems and processes, the system 100 also consumes less energy than conventional printing plate generating systems by eliminating any energy required for drying the printing member 101 after the stripping process that involves a washing step.

In one or more embodiments, as will be discussed in more detail below, the substrate 103 can be mounted in a printing system, for example, on a printing cylinder in the printing system, or the substrate 103 may itself be a printing cylinder itself. The printing member 101 generation, in this embodiment, may be done in situ on-demand. In this example, the substrate 103 is already in position and in perfect registration with the rest of the printing system so that the generated printing member 101 is also in position and in perfect registration with the rest of the printing system. This placement eliminates the conventional operations of aligning a conventional printing plate and on-press registration adjustment, which routinely wastes hundreds of sheets of paper in one or more make-ready steps.

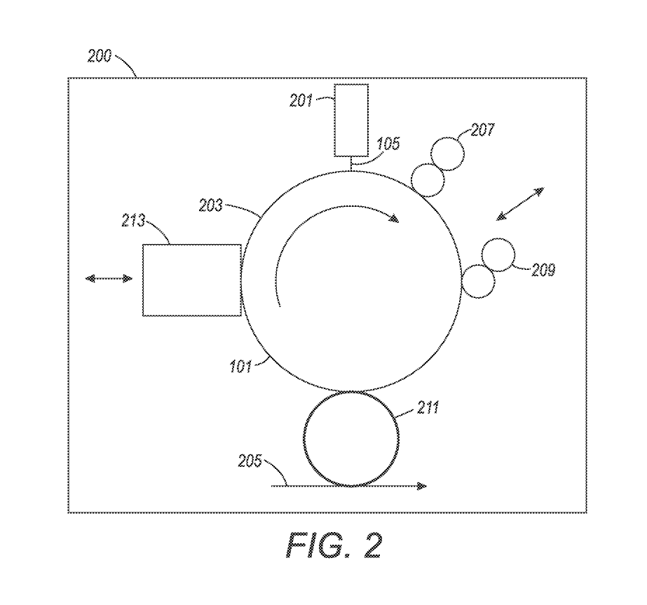

FIG. 2 is a diagram of a printing system 200 that has a printing member generation apparatus 201 such as the system 100 discussed above incorporated into the printing system 200, according to one embodiment. The printing member generation apparatus 201 creates the printing member 101 discussed above on-demand inside of the printing system 200. The printing member 101, in this example, is formed by applying the substance 105 directly to a printing cylinder 203. In this example, the substrate 103 discussed above takes the form of the printing cylinder 203. Though illustrated as the printing cylinder 203, the substrate 103 discussed above, could be a plate wrapped around a conventional printing cylinder such that the printing cylinder itself need not have a substance applied to it as is discussed in this embodiment. The printing system 200 is configured to print an inked image onto a media 205 which may be any material such as paper or a polymer film, for example.

In this example, the printing member generation apparatus 201 applies the substance 105 to the printing cylinder 203 to create the image-wise hydrophobic and hydrophilic areas on the printing cylinder 203. The printing cylinder 203, or at least a surface of the printing cylinder 203, can be either intrinsically hydrophilic or intrinsically hydrophobic. The printing system 200, in this example, may be configured to determine whether the printing cylinder 203 is hydrophobic or hydrophilic and cause a substance 105 having properties opposite that of the determined printing cylinder 203 properties to be applied to generate the printing member. Alternatively, the printing system 200 may be configured to accommodate only one combination of hydrophobic and hydrophilic printing cylinder 203 vs substance 105 properties. For example, the printing cylinder 203 could be a hydrophilic material, such as clean anodized aluminum. Accordingly, the substance 105 could then be a hydrophobic liquid, such as an oil or a wax. Alternatively, the printing cylinder 203 could be hydrophobic. If the printing cylinder 203 is hydrophobic, the printing system 200 applies a hydrophilic substance 105 to the printing cylinder 203 to generate the printing member 101.

In one example embodiment, the printing system 200 also comprises wetting rollers 207, ink rollers 209, a blanket 211, and a cleaner 213. One or more of the wetting rollers 207, inking rollers 209, the blanket 211, and the cleaner 213 may be moveable such that the printing cylinder 203 may be selectively in contact with any of the wetting rollers 207, inking rollers 209, blanket 211, and/or cleaner 213. For example, the wetting rollers 207, ink rollers 209 and cleaner 213 may be moved away from the printing cylinder. In one or more embodiments, the movement of any of the wetting rollers 207, inking rollers 209, blanket 211, and/or cleaner 213, for example, the wetting rollers 207, ink rollers 209 and cleaner 213 may be by way of one or more of a cam, a motor, a lever, a screw, etc.

Once the wetting rollers 207, inking rollers 209, blanket 211, and/or cleaner 213 are moved away from the printing cylinder 203, the printing member generation apparatus 201 applies the substance 105 having the requisite opposite hydrophobic and hydrophilic properties of the printing cylinder 203 to form an image on the printing cylinder 203. As discussed above the substance is applied to one or more image areas and may optionally be hardened. Then the wetting rollers 207 and the inking rollers 209 are moved such that they are in contact with the printing cylinder 203. For example, the hydrophilic portions of the printing cylinder 203 are wetted with water by the wetting rollers 207. These areas repel oily ink applied by the ink rollers 209 so only the hydrophobic portions, i.e. the portions having the hydrophobic substance 105, of the printing cylinder 203 are wetted with ink by the ink rollers 209. The ink is then transferred from the printing cylinder 203 to the media 205 either directly or as shown in the diagram, using an intermediate rubber roll such as the blanket 211 as in conventional offset lithography printing processes. Alternatively, if the printing cylinder 203 is hydrophobic, and the substance 105 is hydrophilic, the wetting properties of the printing member 101 are reversed from that discussed above. As such, if the substance is hydrophilic, the bare portions of the printing cylinder 203 will have the ink adhere to it for printing the image to the media 205.

The above-mentioned wetting/inking/transfer process is repeated for as many identical copies of the printed image that are desired. The printing cylinder 203 may be continually used as a printing plate until a different printed image is desired on the media 205. To enable another printed image to be applied to the media 205, the cleaner 213 is caused to clean the substance 105 from at least selected portions of the printing cylinder 203, thereby making at least the cleaned portions of the printing cylinder 203 bare. For example, in one embodiment, the printing cylinder 203 is cleaned such that it is entirely bare and ready for re-use to apply another image to the media 205. But, in another embodiment, for applications requiring a static image as well as some variable data (e.g., a barcode or serial number) on each page, only a selected narrow section of the printing cylinder 203 may be cleaned off for each page.

In one or more embodiments, the cleaner 213 is moved, for example, by camming the cleaner 213 on to the printing cylinder 203. The cleaner 213 removes the substance 105 (in this example the hydrophobic substance) that corresponds to the image printed onto the media 205 from the printing cylinder 203, for example by solvent and/or abrasion. In one or more embodiments, the cleaner may include a blade to scrape hardened substance from the printing cylinder 203. Then the cleaner 213 may be moved away from the printing cylinder 203 and substance 105 is applied again to form a new positive image on the printing cylinder 203 by the printing member generation apparatus 201. The wetting/inking/transfer process is then repeated as discussed above, for as many copies of an image that are desired.

Alternatively, if a degradation in image quality is detected because of a worn printing member 101 (i.e. the substance 105 that is applied to the printing cylinder 203 wears down), the printing system 200 may cause the printing cylinder 203 to be cleaned and cause the substance 105 to be applied to form another positive image that corresponds to the image currently being printed on the media 205.

If, for example, the printing system 200 is configured for four-color process printing, or any number of colors, four such printing cylinders 203, or any matching number of printing cylinders 203, may be used in tandem for each color.

As discussed above, because the printing member generation apparatus 201 and the printing cylinder 203 are mounted inside of a printing system 200, the cost of making, mounting and aligning the plates on the printing system that is associated with conventional printing plate generation systems and processes is eliminated. Conventional offline printing plate generation is replaced by the accurate on-demand, limited waste printing member generation apparatus 201 that applies the substance 105 to form a positive image on the printing cylinder 203 as opposed to conventional wasteful flood coat techniques that require stripping and washing, for example. Once the substance is applied to the printing cylinder 203 to form a positive image, multiple copies of a printed image can be applied to the media 205 at high speeds.

As such, the printing system 200 facilitates high speed high quality printing associated with conventional lithographic offset printing while being as nimble as a conventional inkjet printing system that has the ability to change printing images on demand, without having to sacrifice image quality as is associated with conventional inkjet printing methods such as feathering and inter-color bleeding, for example. Accordingly, the printing system 200 may be able to effectively accommodate single-copy printing (such as in conventional electrophotography or inkjet printing) while also accommodating print jobs that require more than one copy, such as those that are required for cost-effective lithographic printing processes, and any number in between. For example, the printing system 200 may enable effective offset printing processes for short run print jobs such as, but not limited to, digital labels, document printing, business cards, post cards, flyers, invitations, booklets, brochures, pamphlets, etc. that are not printed on thousands of sheets. But, the printing system 200 may also reduce process time, delays, required storage space, waste, etc. associated with conventional high-volume printing plate generation processes.

In one or more embodiments, the printing system 200 may be adjustable to run at various speeds such as a first speed for applying the substance 105 to the printing cylinder 203 and a second speed for printing the actual production image onto the media 205. For example, the first speed may be a slow-speed, high-quality mode that enables precise application of the substance 105 to the one or more image areas 111 associated with the image to be printed on the media 205, while the second speed may be a higher speed for printing the image on the media 205.

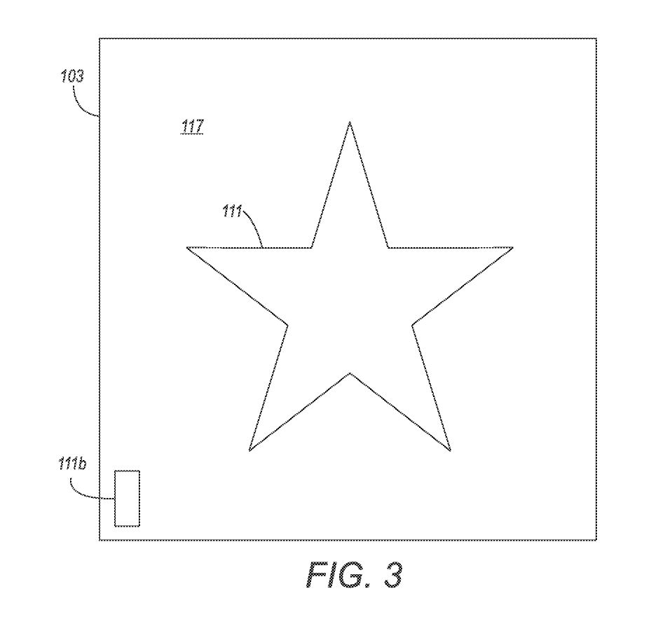

FIG. 3 is a diagram illustrating a substrate 103 having image areas 111 and 111b to which the substance 105, discussed above, has been applied, according to one example embodiment. Bare space 117, in this example, illustrates the non-image areas of the substrate 103. As discussed above, the substrate 103 may be either wrapped around a printing cylinder, or may be a printing cylinder itself. In this example, the image area 111b may represent an area that includes a variable image such as a page or serial number, for example. If the cleaner 213 discussed above is configured to clean the substance 105 from the substrate 103, and if the cleaner 213 is caused to selectively clean the image area 111b leaving image area 111, the image area 111 would remain constant for further copies of the image that are printing onto media 205 discussed above by the printing system 200, while the image area 111b would be cleaned and substance 105 would be reapplied to the image area 111b to enable the variable image to be printed onto media 205, for example, as each copy of the image based on image area 111 is made. As discussed above, the substance 105 may be hardened so that the substrate 105 applied to the image area 111 and 111b become the hardened image areas 115 discussed above.

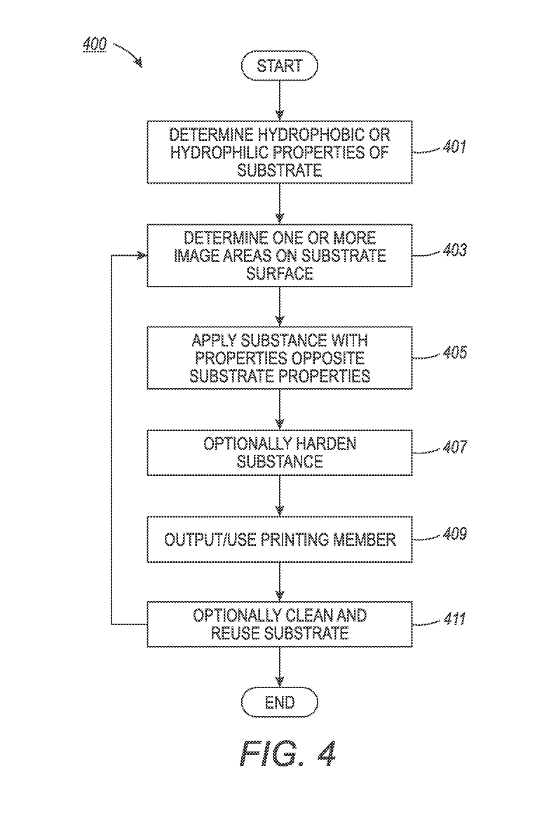

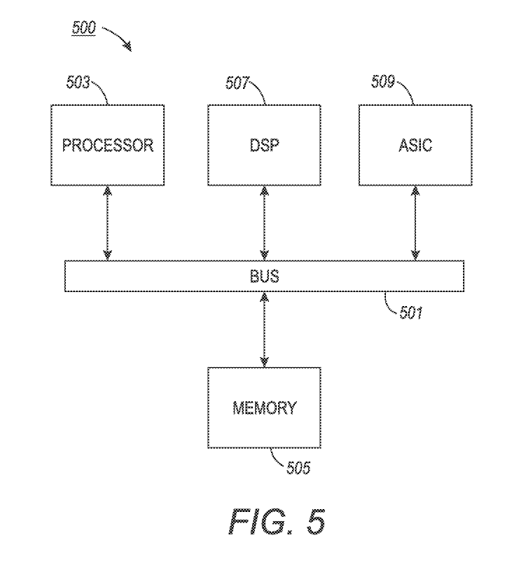

FIG. 4 is a flowchart of a process for generating a printing member by way of a jetting process, according to one embodiment. In one embodiment, the system 100 and/or the printing system 200 performs the process 400 and in some embodiments may comprise a chip set including a processor and a memory as shown in FIG. 5. In step 401, a determination is made regarding a liquid interaction behavior of at least the surface of substrate 103 is one of hydrophobic or hydrophilic. The determination may be made by the system 100, or by an operator, for example. Then, in step 403, the system 100 determines one or more image areas 111 associated with one or more images that are to be printed by a printing system onto a media 205, as discussed above. The one or more image areas 111 are areas on a surface of substrate 103 to which the substance 105 may be applied. Next, in step 405, the system 100 causes, at least in part, the substance 105 that is the other of the determined liquid interaction behavior of the surface of the substrate 103 to be applied by the jets 107 to the one or more image areas 111 associated with the one or more images to be printed.

The process continues to step 407 in which the substance 105 may optionally be hardened. Then, in step 409, the printing member 101 is output by the system 100 for use by a printing system or simply used directly by the printing system 200. Next, in step 411, the jets 107 may optionally be caused to apply substance 105 to the substrate 103 in one or more other image area for one or more other images that are to be printed by a printing system. To generate a printing member for one or more other images, the substrate 103 may optionally be cleaned by the cleaner 213 if the system 100 is implemented in the printing system 200, for example.

The processes described herein for generating a printing member by way of a jetting process may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 5 illustrates a chip set or chip 500 upon which an embodiment may be implemented. Chip set 500 is programmed to generate a printing member by way of a jetting process as described herein may include, for example, bus 501, processor 503, memory 505, DSP 507 and ASIC 509 components.

The processor 503 and memory 505 may be incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 500 can be implemented in a single chip. It is further contemplated that in certain embodiments the chip set or chip 500 can be implemented as a single “system on a chip.” It is further contemplated that in certain embodiments a separate ASIC would not be used, for example, and that all relevant functions as disclosed herein would be performed by a processor or processors. Chip set or chip 500, or a portion thereof, constitutes a means for performing one or more steps of generating a printing member by way of a jetting process.

In one or more embodiments, the chip set or chip 500 includes a communication mechanism such as bus 501 for passing information among the components of the chip set 500. Processor 503 has connectivity to the bus 501 to execute instructions and process information stored in, for example, a memory 505. The processor 503 may include one or more processing cores with each core configured to perform independently. A multi-core processor enables multiprocessing within a single physical package. Examples of a multi-core processor include two, four, eight, or greater numbers of processing cores. Alternatively or in addition, the processor 503 may include one or more microprocessors configured in tandem via the bus 501 to enable independent execution of instructions, pipelining, and multithreading. The processor 503 may also be accompanied with one or more specialized components to perform certain processing functions and tasks such as one or more digital signal processors (DSP) 507, or one or more application-specific integrated circuits (ASIC) 509. A DSP 507 typically is configured to process real-world signals (e.g., sound) in real time independently of the processor 503. Similarly, an ASIC 509 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one or more embodiments, the processor (or multiple processors) 503 performs a set of operations on information as specified by computer program code related to generating a printing member by way of a jetting process. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 501 and placing information on the bus 501. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 503, such as a sequence of operation codes, constitute processor instructions, also called computer system instructions or, simply, computer instructions. Processors may be implemented as mechanical, electrical, magnetic, optical, chemical or quantum components, among others, alone or in combination.

The processor 503 and accompanying components have connectivity to the memory 505 via the bus 501. The memory 505 may include one or more of dynamic memory (e.g., RAM, magnetic disk, writable optical disk, etc.) and static memory (e.g., ROM, CD-ROM, etc.) for storing executable instructions that when executed perform the inventive steps described herein to generate a printing member by way of a jetting process. The memory 505 also stores the data associated with or generated by the execution of the inventive steps.

In one or more embodiments, the memory 505, such as a random access memory (RAM) or any other dynamic storage device, stores information including processor instructions for generating a printing member by way of a jetting process. Dynamic memory allows information stored therein to be changed by system 100. RAM allows a unit of information stored at a location called a memory address to be stored and retrieved independently of information at neighboring addresses. The memory 505 is also used by the processor 503 to store temporary values during execution of processor instructions. The memory 505 may also be a read only memory (ROM) or any other static storage device coupled to the bus 501 for storing static information, including instructions, that is not changed by the system 100. Some memory is composed of volatile storage that loses the information stored thereon when power is lost. The memory 505 may also be a non-volatile (persistent) storage device, such as a magnetic disk, optical disk or flash card, for storing information, including instructions, that persists even when the system 100 is turned off or otherwise loses power.

The term “computer-readable medium” as used herein refers to any medium that participates in providing information to processor 503, including instructions for execution. Such a medium may take many forms, including, but not limited to computer-readable storage medium (e.g., non-volatile media, volatile media), and transmission media. Non-volatile media includes, for example, optical or magnetic disks. Volatile media include, for example, dynamic memory. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

While a number of embodiments and implementations have been described, the invention is not so limited but covers various obvious modifications and equivalent arrangements, which fall within the purview of the appended claims. Although features of various embodiments are expressed in certain combinations among the claims, it is contemplated that these features can be arranged in any combination and order.

What is claimed is:

1. A method for generating a printing member comprising:
determining a liquid interaction behavior of at least a surface of a substrate is one of hydrophobic or hydrophilic;
determining one or more image areas associated with printing one or more images, the one or more image areas being positioned on the surface of a the substrate;
causing, at least in part, a substance that is the other of the determined liquid interaction behavior of the surface of the substrate to be applied to the one or more image areas on the surface of the substrate by a jetting process.

2. A method of claim 1, further comprising:
causing, at least in part, the substance to be hardened.

3. A method of claim 2, wherein the substance is hardened by way of exposure to ultraviolet light.

4. A method of claim 1, wherein the substrate comprises aluminum.

5. A method of claim 1, wherein the substance is a liquid.

6. A method of claim 1, wherein the substance is a gel.

7. A method of claim 1, wherein the substrate is mounted inside of a printing system at a time when the substance is applied to the surface of the substrate.

8. A method of claim 7, wherein the printing system comprises a cleaning device, the method further comprising:
causing, at least in part, the cleaning device to remove at least part of the substance from the surface of the substrate;
determining one or more other image areas associated with printing one or more other images, the one or more other image areas being positioned on the surface of the substrate; and
causing, at least in part, the substance to be applied to the one or more other image areas on the surface of the substrate.

9. A method of claim 8, wherein the cleaning device is configured to selectively remove the substance from the surface of the substrate, thereby leaving one or more positions of the substance on the surface of the substrate following a cleaning process.

10. A method of claim 7, wherein the substrate is a cylinder.

11. An apparatus for generating a printing member comprising:
at least one processor; and
at least one memory including computer program code for one or more programs,
the at least one memory and the computer program code configured to, with the at least one processor, cause the apparatus to perform at least the following,
determine a liquid interaction behavior of at least a surface of a substrate is one of hydrophobic or hydrophilic;
determine one or more image areas associated with printing one or more images, the one or more image areas being positioned on the surface of the substrate; and
cause, at least in part, a substance that is the other of the determined liquid interaction behavior of the surface of the substrate to be applied to the one or more image areas on the surface of the substrate by a jetting process.

12. An apparatus of claim 11, wherein the apparatus is further caused to: cause, at least in part, the substance to be hardened.

13. An apparatus of claim 12, wherein the substance is hardened by way of exposure to ultraviolet light.

14. An apparatus of claim 11, wherein the substrate comprises aluminum.

15. An apparatus of claim 11, wherein the substance is a liquid.

16. An apparatus of claim 11, wherein the substance is a gel.

17. An apparatus of claim 11, wherein the substrate is mounted inside of a printing system at a time when the substance is applied to the surface of the substrate.

18. An apparatus of claim 17, wherein the printing system comprises a cleaning device, and the apparatus is further caused to:
cause, at least in part, the cleaning device to remove at least part of the substance from the surface of the substrate;
determine one or more other image areas associated with printing one or more other images, the one or more other image areas being positioned on the surface of the substrate; and
cause, at least in part, the substance to be applied to the one or more other image areas on the surface of the substrate.

19. An apparatus of claim 18, wherein the cleaning device is configured to selectively remove the substance from the surface of the substrate, thereby leaving one or more positions of the substance on the surface of the substrate following a cleaning process.

20. An apparatus of claim 17, wherein the substrate is a cylinder.
